(19) United States
(12) Patent Application Publication
(10) Pub. No.: US 2014/0204030 A1
(43) Pub. Date: Jul. 24, 2014

(54) MOUSE DEVICE

(71) Applicant: Primax Electronics, Ltd., Taipei (TW)

(72) Inventor: Ya-Jun Li, Taipei (TW)

(73) Assignee: Primax Electronics, Ltd., Taipei (TW)

(21) Appl. No.: 13/951,293

(22) Filed: Jul. 25, 2013

(30) Foreign Application Priority Data
Jan. 22, 2013 (CN) 201320053148.2

(51) Int. Cl. G06F 3/03

(52) U.S. Cl. CPC G06F 3/0304
USPC 345/166

(57) ABSTRACT

A mouse device includes a base and a displacement sensing device. The displacement sensing device includes a light-emitting element, an optical assembly, and an optical sensing element. When the mouse device is moved, a light beam emitted by the light-emitting element is transferred through the optical assembly to be received by the optical sensing element. Consequently, the optical sensing element generates a cursor displacement signal. The optical assembly is integrally formed with the base, and there is no gap between the optical assembly and the base. If electrostatic discharge occurs in the external environment of the mouse device, the electrostatic discharge fails to be introduced into the mouse device.

### FIELD OF THE INVENTION

The present invention relates to an input device, and more particularly to a mouse device for controlling a movement of a cursor.

### BACKGROUND OF THE INVENTION

The widely-used input device of a computer system includes for example a mouse device, a keyboard device, a trackball device, a touchpad device, or the like. Among these input devices, the mouse device is the most prevailing because it is very easy-to-use for most users. When a mouse device is held by the palm of a user, the user may move the mouse device in order to control a movement of a cursor shown on a display screen of a computer.

Hereinafter, the structures and the functions of a conventional mouse device will be illustrated with reference to FIGS. 1 and 2. FIG. 1 schematically illustrates the connection between a conventional mouse device and a computer system. FIG. 2 is a schematic exploded view illustrating a conventional mouse device. The computer system 2 comprises a computer host 21 and a display screen 22. The computer host 21 is in communication with a mouse device 1 and the display screen 22. The computer host 21 has a connecting port 211. A graphic-based window 221 and a cursor 222 are shown on the display screen 22. The mouse device 1 is used for controlling the cursor 222 to have the computer host 21 execute a corresponding command. The mouse device 1 comprises a base 10, an upper cover 11, a displacement sensing device 12, a wheel module 13, a left button switch 14, a right button switch 15, a circuit board 16, a connecting wire 17, and a connector 18. The base 10 has an opening 101. The displacement sensing device 12 is aligned with the opening 101. Moreover, the displacement sensing device 12 is partially exposed outside the opening 101, so that the displacement sensing device 12 can be normally operated.

The upper cover 11 is used for covering the base 10 and supporting the user's palm. The upper cover 11 comprises a perforation 111, a left button part 112, and a right button part 113. The left button part 112 is located at a first side of the perforation 111. The right button part 113 is located at a second side of the perforation 111. The displacement sensing device 12 is disposed on the base 10, and partially exposed outside the base 10. Moreover, the displacement sensing device 12 comprises a light-emitting element 121, an optical assembly 122, and an optical sensing element 123. The light-emitting element 121 is disposed on the circuit board 16 for emitting a light beam. The optical assembly 122 is disposed on the base 10 for allowing the light beam to go through and projecting the light beam on a working surface. For example, the working surface is a desk surface where the conventional mouse device 1 is placed. The optical sensing element 123 is used for receiving the light beam, and generating a cursor displacement signal according to the light beam. That is, when the conventional mouse device 1 is moved by the user, the displacement sensing device 12 detects a displacement amount of the base 10 relative to the working surface and generates the cursor displacement signal according to the displacement amount. According to the cursor displacement signal, the cursor 222 shown on the display screen 22 is moved by the computer host 21.

The wheel module 13 comprises a scroll wheel 131, a rotating shaft 132, an encoder 133, and a wheel switch 134. The scroll wheel 131 is disposed on the base 10. Moreover, the scroll wheel 131 is penetrated through the perforation 111 of the upper cover 11 to be exposed outside the upper cover 11, so that the scroll wheel 131 is rotatable by the user. The rotating shaft 132 is penetrated through the scroll wheel 131, and a first end 1321 of the rotating shaft 132 is inserted into the encoder 133. As the scroll wheel 131 is rotated by the user, the rotating shaft 132 is synchronously rotated with the scroll wheel 131. As the rotating shaft 132 is synchronously rotated with the scroll wheel 131, the encoder 133 is driven to generate a scrolling signal in response to the rotation of the scroll wheel 131. According to the scrolling signal, the graphic-based window 221 shown on the display screen 22 is correspondingly scrolled by the computer host 21. The wheel switch 134 is disposed on the circuit board 16, and disposed under a second end 1322 of the rotating shaft 132. When the scroll wheel 131 is depressed, the second end 1322 of the rotating shaft 132 is moved downwardly to trigger the wheel switch 134. Consequently, the wheel switch 134 generates a wheel button signal. According to the wheel button signal, the computer host 21 executes a corresponding command.

The left button switch 14 is disposed on the circuit board 16, and disposed under the left button part 112. When the left button part 112 is depressed by the user, the left button switch 14 is triggered by the left button part 112 to generate a left button signal. According to the left button signal, the computer host 21 executes a left button command. The right button switch 15 is disposed on the circuit board 16, and disposed under the right button part 113. When the right button part 113 is depressed by the user, the right button switch 15 is triggered by the right button part 113 to generate a right button signal. According to the right button signal, the computer host 21 executes a right button command. An end of the connecting wire 17 is connected with the connector 18. The cursor displacement signal, the scrolling signal, the wheel button signal, the left button signal and the right button signal may be transmitted from the mouse device 2 through the connecting wire 17. Moreover, after the connector 18 is plugged into the connecting port 211 of the computer host 21, the mouse device 1 is in communication with the computer host 21. Moreover, the connector 18 is a universal series bus (USB) for example.

In the conventional mouse device 1, there is a gap between the displacement sensing device 12 and the opening 101 of the base 10. If electrostatic discharge (ESD) occurs in the external environment of the conventional mouse device 1, the electrostatic discharge is readily introduced into the conventional mouse device 1 through the gap. As known, the electrostatic discharge is detrimental to the performance of the mouse device 1. For solving the problem of the electrostatic discharge, another conventional mouse device is disclosed to minimize the influence of the electrostatic discharge.

FIG. 3 is a schematic exploded view illustrating another conventional mouse device. As shown in FIG. 3, the conventional mouse device 3 comprises a base 30, an upper cover 31, a displacement sensing device 32, a wheel module 33, a left button switch 34, a right button switch 35, a circuit board 36, a connecting wire 37, and a connector (not shown). The base 30 has an opening 301. Moreover, the displacement sensing device 32 comprises a light-emitting element 321, an optical assembly 322, and an optical sensing element 323. The structures and operating principles of the conventional mouse device 3 are substantially identical to those of the conventional mouse device 1, and are not redundantly described herein.

In comparison with the conventional mouse device 1, the displacement sensing device 32 of the conventional mouse device 3 further comprises a protection disc 3221. The protection disc 3221 is disposed on a bottom of the optical assembly 322 for sheltering the periphery of the opening 301. If electrostatic discharge (ESD) occurs in the external environment of the conventional mouse device 3, the electrostatic discharge is also introduced into the conventional mouse device 3 through the gap between the opening 301 and the optical assembly 322. Due to the protection disc 3221, the electrostatic discharge should be firstly transferred through the protection disc 3221 along the gap and then introduced into the conventional mouse device 3. During the electrostatic discharge is transferred through the protection disc 3221 along the gap, the electrostatic discharge nearly disappears. In other words, the possibility of introducing the electrostatic discharge into the conventional mouse device 3 is minimized, and thus the problem of the electrostatic discharge is overcome by the conventional mouse device 3.

However, the conventional mouse device 3 still has some drawbacks. For example, for preventing the electrostatic discharge from being introduced into the conventional mouse device 3, the length of the protection disc 3221 should be large enough to allow the electrostatic discharge to be disappeared. Under this circumstance, the protection disc 3221 may occupy a lot of space between the base 30 and the upper cover 31. Moreover, since the protection disc 3221 is disposed on the bottom of the optical assembly 322 and the protection disc 3221 has a specified thickness, the altitudes of the optical assembly 322 and the circuit board 36 are ascended, and more space with the conventional mouse device 3 is increased. Under this circumstance, the overall height and the overall volume of the conventional mouse device 3 are both increased, so that the conventional mouse device 3 fails to meet the requirements of slimness and light weight.

Therefore, there is a need of providing a mouse device for avoiding the influence of the electrostatic discharge without increasing the inner space of the mouse device.

### SUMMARY OF THE INVENTION

The present invention provides a mouse device for avoiding the influence of the electrostatic discharge.

The present invention also provides a mouse device for avoiding the influence of the electrostatic discharge without increasing the inner space of the mouse device.

In accordance with an aspect of the present invention, there is provided a mouse device. The mouse device is in communication with a computer system for controlling a movement of a cursor of said computer system. The mouse device includes a base and a displacement sensing device. The displacement sensing device is disposed on the base, and partially exposed outside the base for generating a cursor displacement signal in response to a movement of the base on a working surface. According to the cursor displacement signal, the movement of the cursor of the computer system is correspondingly controlled. Moreover, the displacement sensing device includes a light-emitting element, an optical assembly, and an optical sensing element. The light-emitting element is used for emitting a light beam. The optical assembly is disposed on the base for allowing the light beam to go through and projecting the light beam on the working surface. The optical sensing element is used for receiving the light beam, and generating the cursor displacement signal according to the light beam. Moreover, the optical assembly is integrally formed with the base, and there is no gap between the optical assembly and the base.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the connection between a conventional mouse device and a computer system;

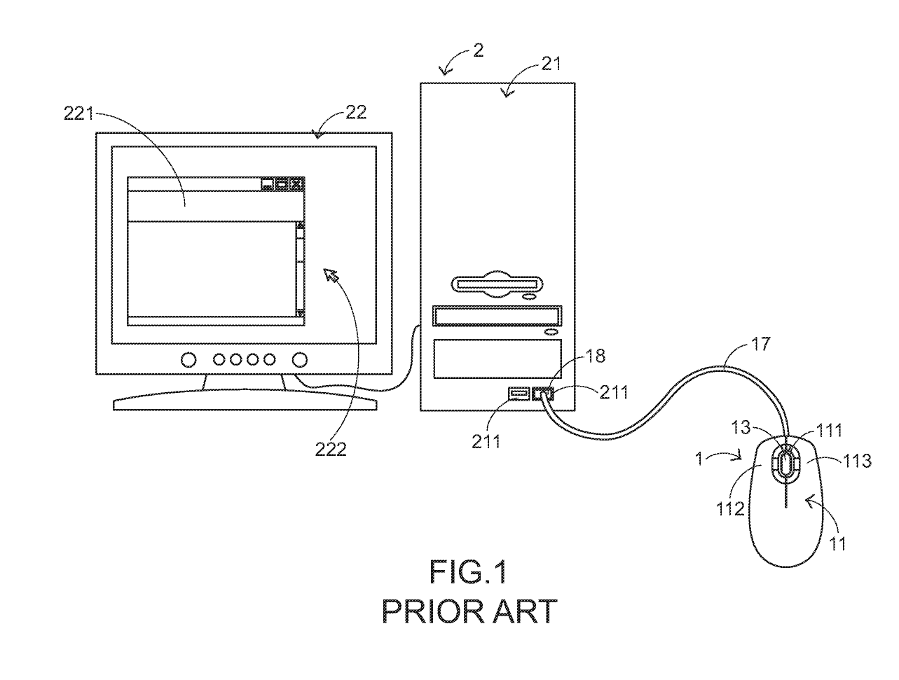

FIG. 2 is a schematic exploded view illustrating the conventional mouse device;

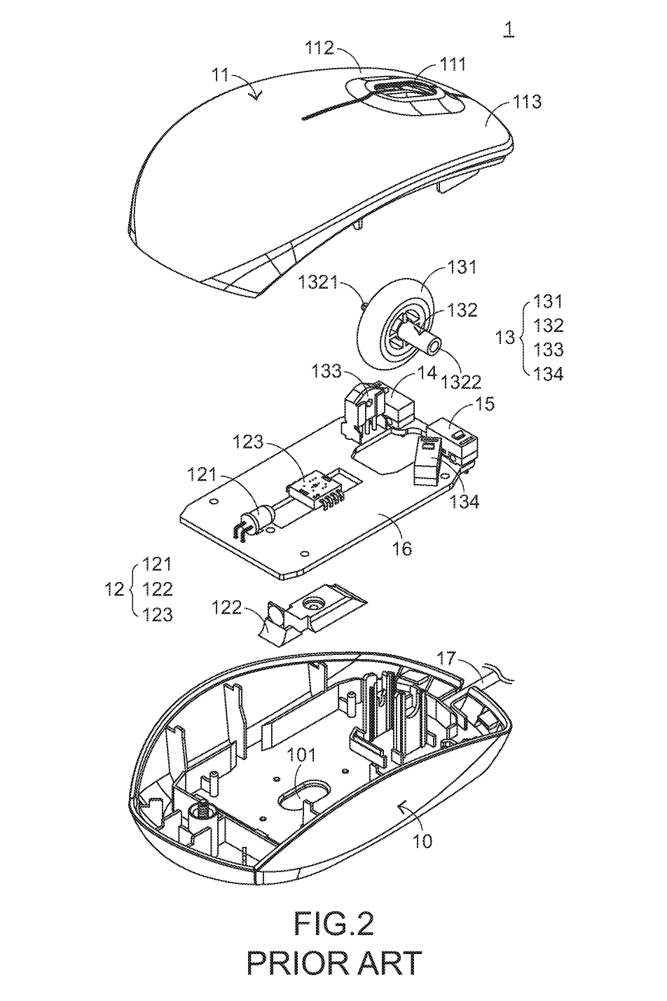

FIG. 3 is a schematic exploded view illustrating another conventional mouse device;

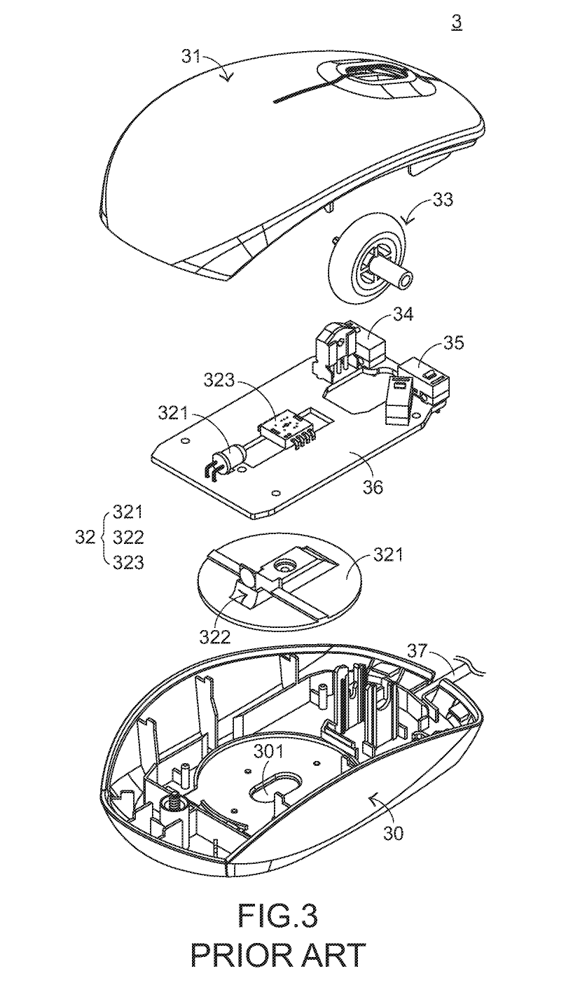

FIG. 4 schematically illustrates the connection between a computer system and a mouse device according to a first embodiment of the present invention;

FIG. 5 is a schematic exploded view illustrating the mouse device according to the first embodiment of the present invention;

FIG. 6 is a schematic side view illustrating the mouse device according to the first embodiment of the present invention;

FIG. 7 is a schematic exploded view illustrating the mouse device according to a second embodiment of the present invention; and

FIG. 8 is a schematic side view illustrating the mouse device according to the second embodiment of the present invention.

### DETAILED DESCRIPTION OF THE PREFERRED EMBODIMENT

For eliminating the drawbacks encountered from the prior art, the present invention provides a mouse device.

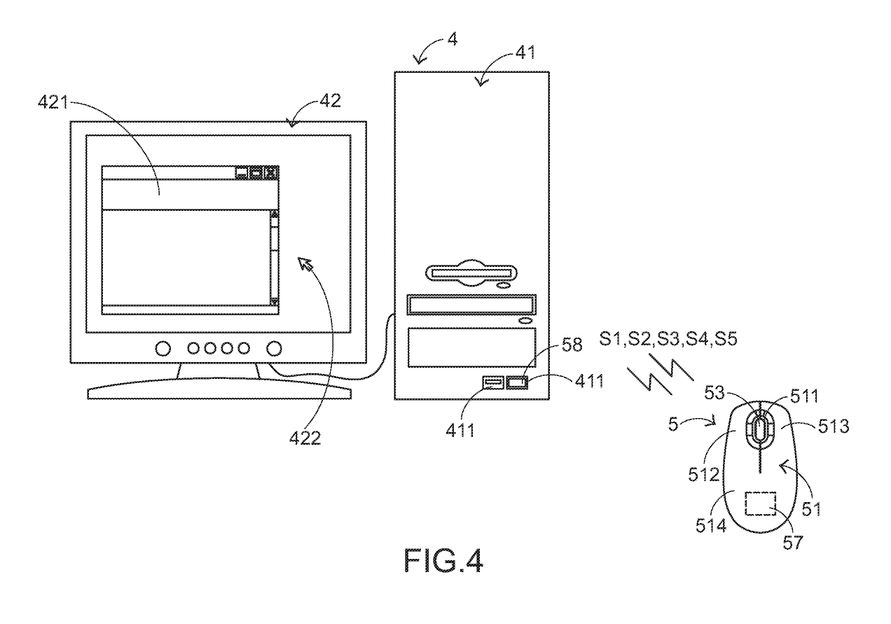

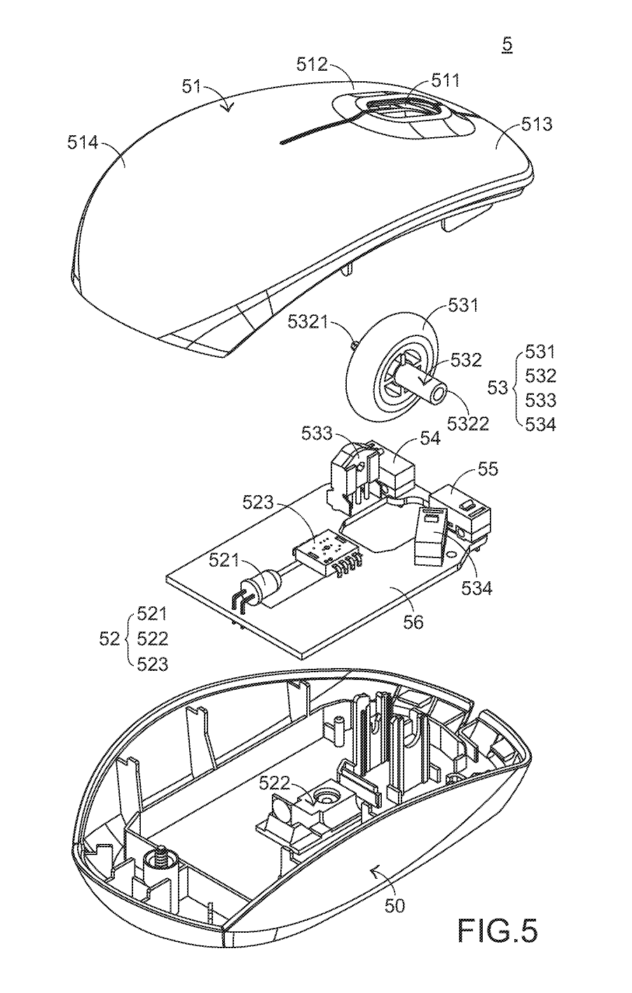

Please refer to FIG. 4 and FIG. 5. FIG. 4 schematically illustrates the connection between a computer system and a mouse device according to a first embodiment of the present invention. FIG. 5 is a schematic exploded view illustrating the mouse device according to the first embodiment of the present invention. As shown in FIG. 4, the computer system 4 comprises a computer host 41 and a display screen 42. The computer host 41 is in communication with a mouse device 5 and the display screen 42. The computer host 41 has a connecting port 411. A graphic-based window 421 and a cursor 422 are shown on the display screen 42. The mouse device 5 is used for controlling a movement of the cursor 422 of the computer host 41. The mouse device 5 comprises a base 50, an upper cover 51, a displacement sensing device 52, a wheel module 53, a first switch 54, a second switch 55, a circuit board 56, a wireless signal transmitter 57, and a wireless signal receiver 58.

As shown in FIG. 4, the wireless signal transmitter 57 is disposed on the circuit board 56. The wireless signal transmitter 57 is used for receiving plural signals from the displacement sensing device 52, the wheel module 53, the first switch 54 and the second switch 5 through the circuit board 56. Moreover, the plural signals are transmitted from the wireless signal transmitter 57 to the wireless signal receiver 58 by a wireless transmission technology. The wireless signal receiver 58 is plugged into the connecting port 411 of the computer host 41. The wireless signal receiver 58 is in communication with the wireless signal transmitter 57 by the wireless transmission technology in order to receive the plural signals from the wireless signal transmitter 57. In this embodiment, the wireless signal receiver 58 is connected with the connecting port 411 through a universal series bus (USB) interface.

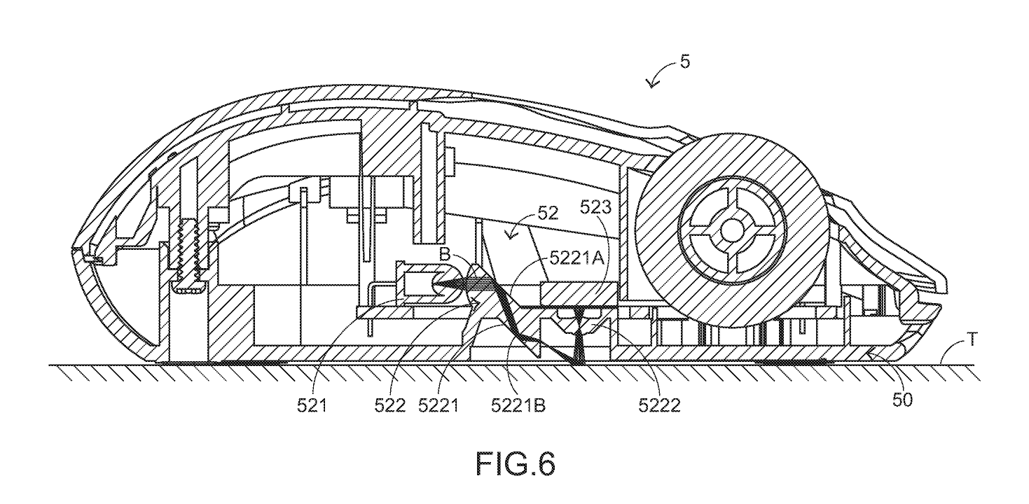

FIG. 6 is a schematic side view illustrating the mouse device according to the first embodiment of the present invention. Please refer to FIGS. 5 and 6. As shown in FIG. 6, the mouse device 5 is placed on a working surface T. In the mouse device 5, the upper cover 51 is used for covering the base 50 and supporting the user's palm. The upper cover 51 comprises a perforation 511, a first button part 512, and a second button part 513. The perforation 511 is located near an end of the upper cover 51. The first button part 512 is located at a first side of the perforation 511. The second button part 513 is located at a second side of the perforation 511. The first switch 54 is disposed on the circuit board 56, and electrically connected with the circuit board 56. In addition, the first switch 54 is disposed under the first button part 512. When the first button part 512 is depressed by the user, the first switch 54 is triggered by the first button part 512 to generate a first button signal S1 (see FIG. 4). According to the first button signal S1, the computer host 41 executes a first button command. The second switch 55 is disposed on the circuit board 56, and electrically connected with the circuit board 56. In addition, the second switch 55 is disposed under the second button part 513. When the second button part 513 is depressed by the user, the second switch 55 is triggered by the second button part 513 to generate a second button signal S2 (see FIG. 4). According to the second button signal S2, the computer host 41 executes a second button command. In this embodiment, the first button signal S1 is a left button signal, and the first button command is a left button command. Moreover, the second button signal S2 is a right button signal, and the second button command is a right button command.

The displacement sensing device 52 is disposed on the base 50, and partially exposed outside the base 50. In response to a movement of the base 50, the displacement sensing device 52 generates a cursor displacement signal S3. According to the cursor displacement signal S3, the cursor 422 of the computer host 41 is correspondingly moved. Moreover, the displacement sensing device 52 comprises a light-emitting element 521, an optical assembly 522, and an optical sensing element 523. The light-emitting element 521 is disposed on the circuit board 56, and electrically connected with the circuit board 56. When the light-emitting element 521 receives electricity from the circuit board 56, the light-emitting element 521 is enabled to emit a light beam B. As shown in FIG. 6, the light-emitting element 521 is located near the optical assembly 522. In addition, the light beam B emitted by the light-emitting element 521 is directed to the optical assembly 522. The optical assembly 522 is disposed on the base 50 for allowing the light beam to go through and projecting the light beam on the working surface T. In this embodiment, the optical assembly 522 is integrally formed with the base 50. Moreover, there is no gap between the optical assembly 522 and the base 50 (see FIG. 6). In this embodiment, the optical assembly 522 and the base 50 are produced by a double injection process. Moreover, an example of the light-emitting element 521 is a light emitting diode (LED).

Please refer to FIG. 6 again. The optical assembly 522 comprises a reflective mirror 5221 and a focusing lens 5222. The reflective mirror 5221 is used for reflecting the light beam B, so that the light beam B is projected on the working surface T. The reflective mirror 5221 comprises a first reflective surface 5221A and a second reflective surface 5221B. The first reflective surface 5221A is located near the light-emitting element 521 for reflecting the light beam B that is emitted by the light-emitting element 521. The second reflective surface 5221B is located near the working surface T. The light beam B reflected by the first reflective surface 5221A is further reflected by the second reflective surface 5221B, so that the light beam B is projected on the working surface T. Moreover, the light beam B reflected by the working surface T is further focused by the focusing lens 5222. After the focused light beam B is received by the optical sensing element 523, the optical sensing element 523 generates the cursor displacement signal S3. In other words, the optical sensing element 523 is used for receiving the light beam B, and generating the cursor displacement signal S3 according to the light beam B.

In a case whether the mouse device 5 is placed on the working surface T but is not moved, the light-emitting element 521 emits the light beam B. The light beam B is projected on the reflective mirror 5221. In the reflective mirror 5221, the light beam B is firstly reflected by the first reflective surface 5221A and the reflected light beam B is further reflected by the second reflective surface 5221B, so that the light beam B is projected on the working surface T. Then, the light beam B is reflected by the working surface T and further focused by the focusing lens 5222. After the focused light beam B is received by the optical sensing element 523, the optical sensing element 523 generates a first working surface image. In a case whether the mouse device 5 is placed on the working surface T and moved to a specified position, the light beam B emitted by the light-emitting element 521 is sequentially reflected by the reflective mirror 5221 and the working surface T and focused by the focusing lens 5222. After the focused light beam B is received by the optical sensing element 523, the optical sensing element 523 generates a second working surface image. Next, the optical sensing element 523 compares the first working surface image with the second working surface image, thereby acquiring a displacement of the base 50 relative to the working surface T and generating the cursor displacement signal S3 according to the displacement amount. That is, when the mouse device 5 is moved on the working surface T, the displacement sensing device 52 detects the displacement of the base 50 relative to the working surface T and generates the cursor displacement signal S3 according to the displacement amount. According to the cursor displacement signal S3, the cursor 422 shown on the display screen 42 is moved by the computer host 41.

Please refer to FIGS. 5 and 6 again. The wheel module 53 is disposed on the base 50, and partially exposed outside a top surface 514 of the upper cover 51. When the wheel module 53 is scrolled by the user, the wheel module 53 generates a scrolling signal S4 (see FIG. 4) to the computer host 41 for controlling the scrolling action of the graphic-based window 421 of the computer host 41. The wheel module 53 comprises a scroll wheel 531, a rotating shaft 532, an encoder 533, and a wheel switch 534. The scroll wheel 531 is disposed on the base 50. Moreover, the scroll wheel 531 is penetrated through the perforation 511 of the upper cover 51 to be exposed outside the top surface of the upper cover 51, so that the scroll wheel 531 is rotatable by the user. The rotating shaft 532 is penetrated through the scroll wheel 531, and a first end 5321 of the rotating shaft 532 is inserted into the encoder 533. As the scroll wheel 531 is rotated by the user, the rotating shaft 532 is synchronously rotated with the scroll wheel 531. As the rotating shaft 532 is synchronously rotated with the scroll wheel 531, the encoder 533 is driven to generate the scrolling signal S4 corresponding to the rotation of the scroll wheel 531. According to the scrolling signal S4, the graphic-based window 421 shown on the display screen 42 of the computer system 4 is correspondingly scrolled by the computer host 41. The wheel switch 534 is disposed on the circuit board 56, and disposed under a second end 5322 of the rotating shaft 532. When the scroll wheel 531 is depressed, the second end 5322 of the rotating shaft 532 is moved downwardly to trigger the wheel switch 534. Consequently, the wheel switch 534 generates a wheel button signal S5 (see FIG. 4). According to the wheel button signal S5, the computer host 51 executes a corresponding command.

During operations of the mouse device 5, the first button signal S1, the second button signal S2, the cursor displacement signal S3, the scrolling signal S4 and the wheel button signal S5 are generated by the mouse device 5. These signals S1˜S5 are transmitted to the wireless signal transmitter 57 through the circuit board 56, and then these signals S1˜S5 are transmitted from the wireless signal transmitter 57 to the wireless signal receiver 58 by the wireless transmission technology. According to these signals S1˜S5, the computer host 41 executes corresponding commands, respectively.

As is understood from FIGS. 5 and 6, since the optical assembly 522 is integrally formed with the base 50, there is no gap between the optical assembly 522 and the base 50. If electrostatic discharge (ESD) occurs in the external environment of the mouse device 5, the electrostatic discharge fails to be introduced into the mouse device 5 through the region between the optical assembly 522 and the base 50. Consequently, the influence of the electrostatic discharge is minimized. Moreover, since it is not necessary to install the large-sized protection disc and the circuit board 56 with a smaller size may be adopted, the inner space of the mouse device 5 is largely reduced. Consequently, the mouse device 5 can meet the requirements of slimness and light weight, and the mouse device 5 has small overall volume.

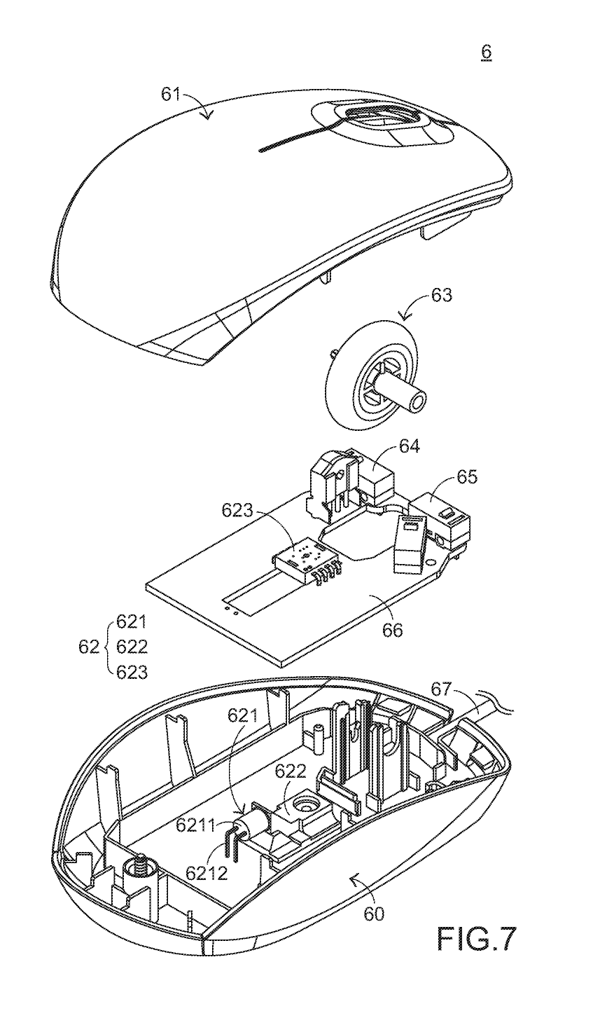

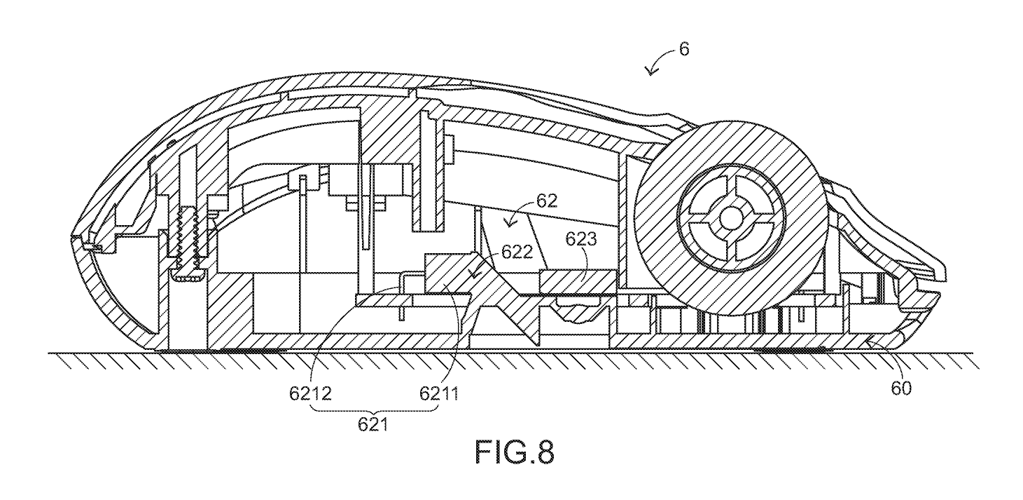

The present invention also provides a mouse device of a second embodiment. FIG. 7 is a schematic exploded view illustrating the mouse device according to a second embodiment of the present invention. FIG. 8 is a schematic side view illustrating the mouse device according to the second embodiment of the present invention. As shown in FIGS. 7 and 8, the mouse device 6 comprises a base 60, an upper cover 61, a displacement sensing device 62, a wheel module 63, a first switch 64, a second switch 65, a circuit board 66, and a connecting wire 67. Moreover, the displacement sensing device 62 comprises a light-emitting element 621, an optical assembly 622, and an optical sensing element 623. The light-emitting element 621 comprises a light shade 6211 and plural pins 6212. The structures and operating principles of the mouse device 6 are substantially identical to those of the mouse device 5 of the first embodiment, and are not redundantly described herein.

Except for the following items, the mouse device 6 is substantially identical to the mouse device 5 of the first embodiment.

Firstly, the light-emitting element 621 of the mouse device 6 is integrally formed with the optical assembly 622 and the base 60. The light shade 6211 of the light-emitting element 621 and the optical assembly 622 are made of resin materials. The pins 6212 are partially shaded by the light shade 6211. That is, the light-emitting element 621 and the optical assembly 622 are produced by an insert injection process. The optical assembly 622 and the base 60 are produced by a double injection process. Similarly, there is no gap between the optical assembly 622 and the base 60.

Secondly, the mouse device 6 of this embodiment is in communication with a computer system (not shown) through the connecting wire 67. That is, during operations of the mouse device 6, the first button signal, the second button signal, the cursor displacement signal, the scrolling signal and the wheel button signal are generated by the mouse device 6. These signals are transmitted to the computer system through the connecting wire 67.

It is noted that numerous modifications and alterations of the connection member may be made while retaining the teachings of the invention. For example, in some embodiments, the wheel module is a swingable wheel module with a tilting function in order to generate a left tilting signal or a right tilting signal to the computer system. According to the left tilting signal or the right tilting signal, the computer system executes a corresponding command of horizontally scrolling the window. Alternatively, in some other embodiments, the mouse device may be equipped with a touch module, an optical finger navigation (OFN) module or a membrane switch circuit module to generate the scrolling signal in replace of the wheel module.

From the above two embodiments of the mouse of the present invention, the optical assembly is integrally formed with the base, so that there is no gap between the optical assembly and the base. If electrostatic discharge (ESD) occurs in the external environment of the mouse device, the electrostatic discharge fails to be introduced into the mouse device through the region between the optical assembly and the base. Consequently, the influence of the electrostatic discharge is minimized, and the performance of the mouse device is not adversely affected. Moreover, since the optical assembly is integrally formed with the base, the assembling cost of assembling the optical assembly with the base will be reduced. On the other hand, since the large-sized protection disc is not disposed on the optical assembly and a small-sized circuit board is used, the overall height and the overall volume of the mouse device are not increased.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A mouse device in communication with a computer system for controlling a movement of a cursor of said computer system, said mouse device comprising:
a base; and
a displacement sensing device disposed on said base, and partially exposed outside said base for generating a cursor displacement signal in response to a movement of said base on a working surface, wherein according to said cursor displacement signal, said movement of said cursor of said computer system is correspondingly controlled, wherein said displacement sensing device comprises:
a light-emitting element for emitting a light beam;
an optical assembly disposed on said base for allowing said light beam to go through and projecting said light beam on said working surface; and
an optical sensing element for receiving said light beam, and generating said cursor displacement signal according to said light beam, wherein said optical assembly is integrally formed with said base, and there is no gap between said optical assembly and said base.

2. The mouse device according to claim 1, wherein said optical assembly comprises:
a reflective mirror for reflecting said light beam, so that said light beam is projected on said working surface; and
a focusing lens, wherein after said light beam reflected by said working surface is focused by said focusing lens, said focused light beam is received by said optical sensing element, so that said optical sensing element generates said cursor displacement signal.

3. The mouse device according to claim 2, wherein said reflective mirror comprises:
a first reflective surface located near said light-emitting element for reflecting the light beam that is emitted by said light-emitting element; and
a second reflective surface located near said working surface, wherein said light beam reflected by said first reflective surface is further reflected by said second reflective surface, so that said light beam is projected on said working surface.

4. The mouse device according to claim 1, wherein said light-emitting element is located near said optical assembly, and said light beam emitted by said light-emitting element is directed to said optical assembly.

5. The mouse device according to claim 1, wherein said light-emitting element is integrally formed with said optical assembly and said base.

6. The mouse device according to claim 1, further comprising an upper cover for covering said base, wherein said upper cover comprises:
a perforation located near an end of said upper cover;
a first button part located at a first side of said perforation, wherein when said first button part is depressed, a first switch is triggered by said first button part to generate a first button signal to said computer system; and
a second button part located at a second side of said perforation, wherein when said second button part is depressed, a second switch is triggered by said second button part to generate a second button signal to said computer system.

7. The mouse device according to claim 6, further comprising a wheel module, which is disposed on said base and partially exposed outside a top surface of said upper cover, wherein by rotating said wheel module, said wheel module generates a scrolling signal to said computer host for controlling a scrolling action of a window of said computer system, wherein said wheel module comprises:
a scroll wheel disposed on said base, and penetrated through said perforation of said upper cover to be exposed outside said top surface of said upper cover, so that the scroll wheel is rotatable; and
an encoder connected with said scroll wheel, wherein in response to rotation of said scroll wheel, said encoder generates said scrolling signal to said computer system.

8. The mouse device according to claim 7, wherein said wheel module further comprises:
a rotating shaft penetrated through said scroll wheel and inserted into said encoder, wherein as said scroll wheel is rotated, said rotating shaft is synchronously rotated with said scroll wheel, wherein in response to rotation of said rotating shaft, said encoder generates said scrolling signal to said computer system; and
a wheel switch disposed under said rotating shaft, wherein when said scroll wheel is depressed, said rotating shaft is moved downwardly to trigger said wheel switch, so that said wheel switch generates a wheel button signal to said computer system.

9. The mouse device according to claim 1, further comprising:
a circuit board electrically connected with said light-emitting element and said optical sensing element for providing electricity to said light-emitting element or transferring said cursor displacement signal from said optical sensing element to said computer system;
a first switch located at a first side of said circuit board and electrically connected with said circuit board, wherein when said first switch is triggered, said first switch generates a first button signal to said computer system; and
a second switch located at a second side of said circuit board and electrically connected with said circuit board, wherein when said second switch is triggered, said first switch generates a second button signal to said computer system.

10. The mouse device according to claim 9, further comprising an upper cover for covering said base, wherein said upper cover comprises:
a perforation located near an end of said upper cover;
a first button part located at a first side of said perforation and disposed over said first switch, wherein when said first button part is depressed, a first switch is triggered by said first button part to generate a first button signal to said computer system; and
a second button part located at a second side of said perforation and disposed over said second switch, wherein when said second button part is depressed, a second switch is triggered by said second button part to generate a second button signal to said computer system.
